(19) United States
(12) Patent Application Publication
(10) Pub. No.: US 2010/0017173 A1
(43) Pub. Date: Jan. 21, 2010

(54) METHOD OF MODELLING THE SWITCHING ACTIVITY OF A DIGITAL CIRCUIT

(75) Inventors: Benoit Emmanuel Fabin, Grenoble (FR); Francois Clement, Virieu Sur Bourbre (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: COUPLING WAVE SOLUTIONS CWS, Moirans (FR)

(21) Appl. No.: 12/373,483

(22) PCT Filed: Jul. 12, 2007
(86) PCT No.: PCT/FR2007/051646

§ 371 Date: Sep. 16, 2009

(30) Foreign Application Priority Data
Jul. 13, 2006 (FR) 0652987

(51) Int. Cl. G06F 17/11; G06F 17/50

(52) U.S. Cl. 703/2

(57) ABSTRACT

The present invention is a method for modeling the switching activity of a digital circuit, this digital circuit comprising cells linked together by interconnections, these cells switching at an instant at which at least one of their inputs changes state, successive switchings of the cells of the circuits occurring during a clock period Tclk of this circuit, the clock period includes the following steps:
calculating based on an adapted statistical model the number of cells liable to switch over each time interval [tk, tk+1] of the clock period, and
allocating switching instants to the different cells of the digital circuit based on the knowledge of the number of cells liable to switch over the time intervals [tk; tk+1].

The present invention is further a production method.

### PRIORITY CLAIM

The present application is a national stage entry of PCT Application No. PCT/FR2007/051646, filed Jul. 12, 2007 which claims priority from French Application No. 0652987, filed Jul. 13, 2006, the disclosures of which are hereby incorporated by reference in their entirety.

### TECHNICAL FIELD

The present invention relates to digital circuits. More particularly, the present invention relates to verifying the integrity of the signals in a system.

### BACKGROUND OF THE INVENTION

This invention relates to a method of modeling the switching activity of a digital circuit. The invention is an alternative to exhaustive or pseudo-exhaustive simulation to determine the switching activity of a circuit, since the invention is not a simulation method. The invention makes it possible to calculate a switching activity model of a circuit quickly without it being necessary to know the precise architecture of this circuit.

The invention has a particularly advantageous application in the field of signal integrity software in a mixed signal electronic system comprising analog and digital circuits. As a non-limiting example, electronic systems encompass integrated circuits on a single silicon block, or on several silicon substrates in the same package, as well as the assembly of (integrated or non-integrated) components on a printed circuit.

Producing these electronic systems is a very costly operation, particularly if the system comprises one or more silicon integrated components. Thus, before beginning large-scale production, it is essential to check all the production parameters and to give some of these parameters values that make it possible to maximize the probability that the circuit produced will work correctly.

To this end, there is a set of software products called “electronic design automation tools” that help with electronic system design from the description of the specification of the system to be produced to producing the photomasks used when the system is produced.

One of the important components in designing an electronic system is quantifying the noise produced by the circuits, particularly in a mixed signal system. Effectively, prior to production, one step consists in verifying the integrity of the signals in a system, that is, in mapping the noise that can be observed inside the system precisely in order to determine whether or not certain noise-sensitive circuits will function.

To this end, noise generator circuits (aggressors) and noise sensitive circuits (victims) are identified. More specifically, all the circuits of the system may be considered noise generators (aggressors). However, it is preferable to select the noise generator circuits from the group that includes: digital circuits, memory cells, analog and radio frequency (RF) circuits such as VCOs (Voltage Controlled Oscillators), power amplifiers and input-output circuits. Digital circuits in particular have a tendency to generate noise when their input signals switch. Of course, a circuit comprising at least one noise generator circuit is itself considered a noise generator circuit.

Noise sensitive circuits (victims) are selected from the group that includes: analog and RF circuits such as amplifiers, filters, oscillators, mixers, sampler-blockers, digital memory circuits, phase loops, input-output circuits and voltage reference circuits. Of course, a circuit comprising at least one noise sensitive circuit is itself considered noise sensitive.

The noise generated by the aggressors spreads toward the victims, passing through the substrates in which the circuits are integrated, the metal interconnections and the packages. This noise tends to degrade the performance of the victims. Thus, noise means any signal generated by an aggressor block that has an undesired influence on the victims.

More specifically, the noise observable in these systems is tied to the switching activity of the digital cells making up the digital circuits of the system. In design assistance software, it may, therefore, be necessary to know the switching activity of the digital part of an integrated circuit, that is, to know the instants at which each cell switches, in order to determine at what moment the cells inject noise inside the electronic system.

A cell that switches is a cell whose inputs change logic state; a logic state (0 or 1) corresponds to a voltage range. Logic state 0 may, for example, correspond to a voltage of between 0 and 5% of the supply voltage of a cell, while logic state 1 may, for example, correspond to a voltage of between 95 and 100% of the supply voltage of a cell. The cell displays internal activity as soon as one of its inputs changes state.

With respect to the specific problems of signal integrity software for integrated systems prior to manufacture, it may be useful to determine the bounds for the switching activity prevailing in this circuit. Thus, it may be useful to determine the maximum activity for which the largest number of cells of the circuit switch, the minimum activity for which the smallest number of cells switch or the average activity, that is, the activity most often observable when the circuit is operating. From these maximum, minimum and average activity levels it is possible to deduce power supply dimensioning data such as the maximum power consumed by a circuit and/or elements in order to reconstruct the maximum, minimum and average noise generated by this circuit.

When using known methods to determine the switching activity of a digital circuit, we exhaustively or pseudo-exhaustively simulate the behavior of the circuits. In an exhaustive simulation, we apply all the input signal combinations (or test patterns) possible to the primary inputs of the circuit, that is, the inputs that can be controlled from the outside. And we then observe at what instants each cell switches based on their respective input signals.

While in a pseudo-exhaustive simulation, we apply to the inputs of the circuit certain signal combinations that may be chosen randomly from all the combinations possible. We then construct a switching activity estimator from a case sampling compared to all the test patterns possible.

The switching activity, whether average or bounded, may be determined using a SPICE transistor-level model of the circuit. This modeling makes it possible to very precisely simulate switching activity for given input signals, but requires a lot of resources and is applicable only with circuits of small size.

It is also possible to simulate the switching activity using behavioral models (VHDL, VERILOG) used in the simulation of VLSI (Very Large Scale Integration) circuits that may comprise a very large number of logic gates, i.e., several million logic gates in one example.

The behavioral simulation methods offer different simulation levels. The first level is the functional simulation stricto sensu of the cells in which no information propagation time is taken into consideration. A second simulation level takes into account the internal switching times of the cells (time to change from one logic state to another). A third simulation level takes into account the internal switching times, as well as the information propagation times on the lines between the cells (wire delay).

However, behavioral or detailed simulation techniques such as the SPICE modeling require the use of a large number of test patterns to calculate average and/or bounded activity. For N inputs that can take on two logic states, 2̂N*(2̂N−1) test patterns need to be applied to the primary inputs of the circuit for exhaustive processing; this results in a very long processing time.

Other methods, such as graph resolution simulation, Petri networks, methods based on Markov chains or probability matrices also make it possible to determine the switching activity of cells. These non-simulative techniques are based on the stochastic behavior of each cell and generate behavior data for the digital circuit. With these techniques, the digital circuit does not react specifically to limited test patterns, but to an average behavior of the cells. However, these graph resolution techniques only reveal the average activity of the circuit.

Furthermore, both simulation techniques and techniques based on graph resolution require knowledge of the entire architecture of the circuit. An estimate of the switching activity during floorplanning or RTL simulation states, that is, an estimate of the switching activity before logical synthesis, is therefore not possible using the known methods if only the number of circuit gates is known.

The invention offers a solution to the problems stemming from the complex implementation of the existing techniques and offers a broader application when the entire architecture of the circuit is not known.

The invention results from a simple finding concerning how signals are transmitted in a digital circuit. When the digital circuit is excited by a clock signal and/or the application of an excitation signal to inputs of this circuit, the cells connected to the inputs of this circuit switch and transmit a signal to the following cells that are connected to them; the signals are thus transmitted step by step within the circuit. The switching activity therefore increases until it reaches an activity peak. Then the activity decreases until the different cells have switched for this clock signal or this excitation signal.

Thus, based on experience, we can apply switching activity profile models that generically satisfy this finding concerning the changes in switching activity. These activity profiles may result from known statistical distribution models such as Normal distribution or Poisson distribution models.

The statistical distribution that is the most relevant for the finding made is Poisson distribution, which introduces the notion of “service” of the digital cells or “queue.” We thus establish a correspondence between this notion of service and the number of cells liable to switch for a particular excitation signal. The Poisson distribution model thus indicates the number of cells that switched over time (the distribution area), to ultimately give a total area representative of the number of cells that switched for a given clock edge or excitation signal.

To this end, the Poisson mathematical model is adapted empirically to physical criteria that account for the actual switching activity of the cells. In other words, the model is adapted to physical parameters according to which it is likely that the distribution of switching instants will vary as a function of time.

Poisson distribution as adapted is thus parameterable according to the number of cells liable to switch (estimate or determination), the average fanout value encountered for each cell and the minimum time for transmitting information from one cell to another.

The fanout of each cell gives the number of cells connected to the output of each cell considered. While the minimum transmission time is the minimum of the sum of the gate delay and the wire delay.

This Poisson distribution has the advantage of making it possible to model the switching activity inside a digital circuit without knowing precisely the complete description of the cells of this circuit and the connections between them. With one simple bit of information concerning the cell population (number of cells, average fanout, etc,) it is possible to model the switching activity of the circuit early in the design flow, for example, before the logic synthesis of the digital circuit.

Based on the analysis of this switching activity it is, more particularly, possible to dimension the power supplies and associate switching instants with cell macro-models modeling noise injection in order to develop a map of the noise in the mixed signal system.

### SUMMARY OF THE INVENTION

The invention therefore relates to a method of modeling the switching activity of a digital circuit, this digital circuit comprising cells linked together by interconnections, these cells switching at an instant at which at least one of their inputs changes state. Successive switchings of the cells of the circuit occur during a clock period Tclk, this clock period Tclk being the time over which a signal input into the circuit is processed by the cells of this digital circuit,

wherein, since the clock period is divided into time intervals, it includes the following steps:
calculating, on the basis of an adapted statistical model, the number of cells liable to switch over each time interval of the clock period, and
allocating switching instants to the different cells of the digital circuit based on the knowledge of the number of cells liable to switch over the time intervals.

### BRIEF DESCRIPTION OF THE DRAWINGS

The invention will be better understood by reading the following description and examining the figures that accompany it. These figures are given for illustration purposes only and do not limit the invention in any way. These figures show:

FIG. 1: a graphic representative of a statistical switching activity model according to the invention developed on the basis of a Poisson model and a schematic representation of the distribution of the switching intervals to the different cells of a digital circuit;

FIG. 2: an algorithm according to the invention adapting the Poisson distribution to obtain discrete values for the cells liable to switch during the time intervals of a clock period;

FIG. 3: a schematic representation of several activity profiles according to the invention of a circuit during a clock period, the Poisson activity model taking into account several stimuli in a reference period of an electronic system;

FIG. 4: a schematic representation of steps of a variant of the invention in which the Poisson distribution is divided up into equal areas corresponding to the calls of the same number of cells in a given time interval.

### DETAILED DESCRIPTION OF THE DRAWINGS

Identical elements retain the same reference from one figure to another.

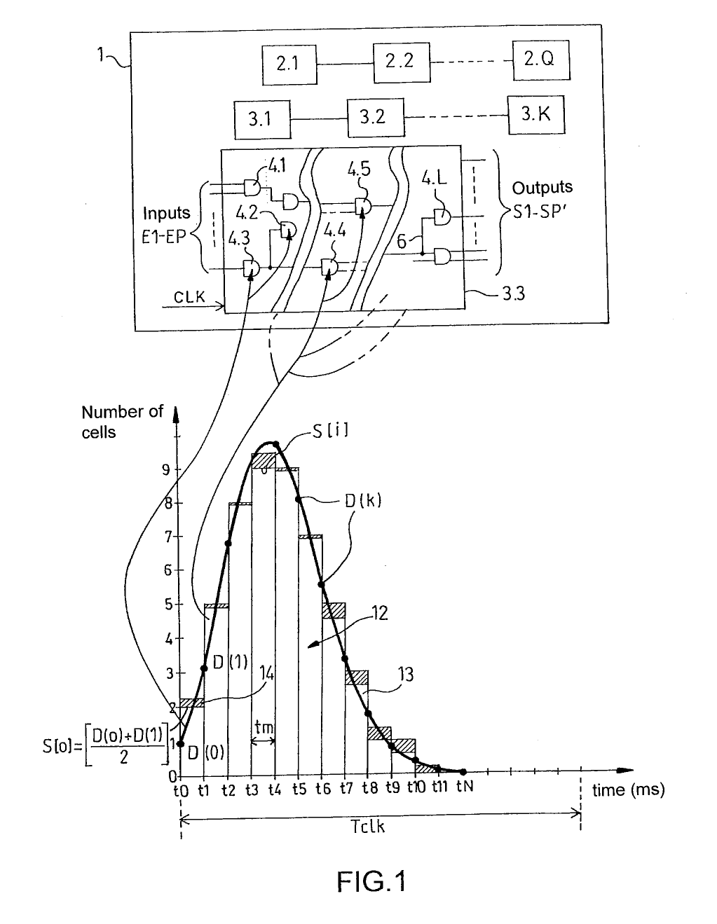

FIG. 1 gives a schematic representation of a mixed signal electronic system 1 comprising analog blocks 2.1-2.Q and digital blocks 3.1-3.K. Digital block 3.3 comprises digital cells 4.1-4.L. Each cell 4.1-4.L comprises one or more logic gates and performs a particular function. These cells 4.1-4.L are linked together by interconnections 6. The changes in state of these cells 4.1-4.L are synchronized by a clock signal CLK applied to the clock inputs of the block 3.3.

This clock signal CLK has a period Tclk, which is the period over which a signal applied to the primary inputs E1-EN of the block is processed by cells 4.1-4.L of block 3.3.

To determine the switching activity model of digital block 3.3, for example, we use the adapted discrete Poisson distribution with the following equation:

$$D [ k ] e \hat{} λ \cdot \frac{λ \hat{} k}{k !} \cdot Na$$

$$where$$

$$Avec λ = \frac{log ( ( \overline{fa} - 1 ) \cdot Na + 1 )}{log ( \overline{fa} )}$$

The Poisson distribution has thus been adapted to the average fanout of the cells f̅a̅ and to the number of cells liable to switch Na, k being a positive integer.

More specifically, Na is the number of cells of the circuit liable to be called over a clock period Tclk, that is, those liable to receive a variation in their inputs. Na is used to make the unit area (=1) of the Poisson distribution correspond to a number of cells Na.

We can select Na so that it is equal to the number of cells L of block 3.3. However, in general, we select a number of cells liable to switch that is lower than the total number of cells of the circuit, for a cell whose inputs change state may have an output that does not change state. Now, the following cells connected after such a cell do not receive any modification of their inputs. Thus, if little technical information is available concerning the circuit, we select Na=L/2, which is representative of the average switching activity of a digital block.

As a variant, to determine Na, we can resolve a graph with the call probabilities for the cells and the probabilities of a change of state of the different nodes between cells; a node corresponds to an interconnection between several cells.

f̅a̅ is the average fanout of the cells of the circuit that switch, that is, the average number of cells connected to the output of each cell of the circuit. For example, for a circuit that has a first cell with an output connected to inputs of two other cells and a second cell with an output connected to an input of another cell, the fanout is (2+1)/2=1.5.

In practice, it is possible to determine the average fanout from a list of information about block 3.3 called a netlist. This netlist includes information about cells 4.1-4.L and the interconnections between these cells. If this information is not available, we know from experience that the average fanout of an electronic circuit may be equal to 2, 3 or 4 as an initial hypothesis.

We also adapt the discrete distribution by making the discrete units of time k correspond to instants tk-k*tm. k is an integer belonging to [0; int(Tclk/tm)], int(Tclk/tm) representing the entire part of Tclk/tm. tm is the minimum time for transmitting information from one cell to another inside digital block 3.3.

The duration tm is defined by the minimum time separating two switchings of two successive cells, one being connected to the input of the other and controlling it. The duration tm results from the combination of two time periods. The first is the switching time of a cell, which is the time for the cell to change state when one of its inputs receives a rising or falling edge. The second is the signal transmission time between the cells, which corresponds to the signal propagation time on the interconnections between cells tied in particular to the RC line networks and to the input capacities of cells 4.1-4.L. The duration tm, which is shorter than Tclk, could also be a constant value other than the minimum time between two switchings of two successive cells.

In one implementation, we calculate the values of D[k] for integer k belonging to [0 . . . int(Tclk/tm)], and we associate these values with discrete instants tk=k.tm. We thus obtain the points represented in FIG. 1. It should be noted that the discrete distribution D[k] of this figure was obtained for block 3.3 with Na=50, f̅a̅=2, tm=1 ms and Tclk=17 ms.

We then calculate the distribution values for time intervals [tk; tk+1]. To do this we perform a linear interpolation between D[k] and D[k+1] using the following formula:

S[i]=(D[k+1]+D[k])/2

Where i, interval, is an integer belonging to [0; int(Tclk/tm)−1], int(Tclk/tm) representing the integer part of Tclk/tm.

Thus, for example, if D[0]=1 and D[1]=3.3, the linear interpolation for [t0; t1] is S[i]=2.15.

By multiplying the integer part of S[1] by the time interval tm, we get approximate values for the Poisson distribution area over each time interval. In other words, we get an approximate value for the number of cells liable to switch during this time interval. The values thus obtained are actual values.

To adapt these calculated actual values to actual situations where a whole number of cells is called over a given time interval, we redistribute the actual values of S[i].tm as integer values.

To this end, we round S[i].tm to the nearest integer and we associate this rounded integer with the corresponding interval. Thus, the number of cells liable to switch over the time interval [t0; t1] is equal to the integer part of (2.15.tm).

We thus obtain a bar graph 12, the area of each bar 13 giving a whole number of cells liable to switch for each time interval [tk; tk+1]. The area of all the bars 13 is equal to the total number of cells liable to be called (in other words, to switch) during a clock period Tclk.

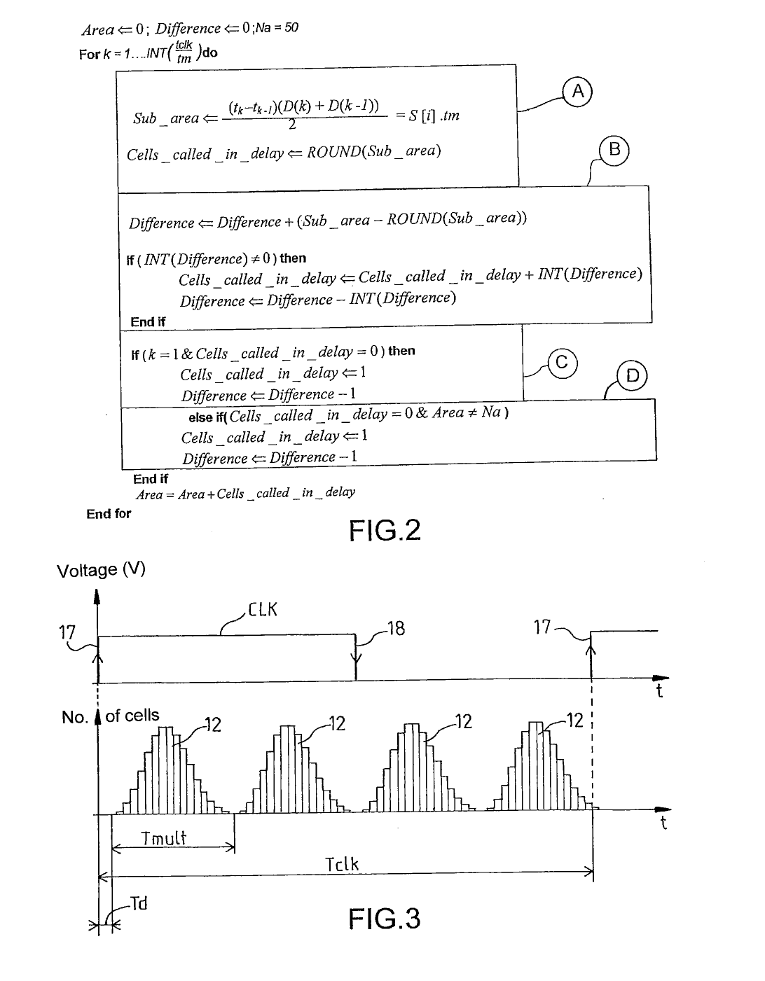

The instructions of part A of the algorithm of FIG. 2, which are included within a loop used for each interval [tk; tk+1], make it possible to calculate the whole number of cells switching over an interval. To this end, we define the “Sub_area” variable, which is equal to S[i] multiplied by tm. And, using the ROUND function, we round this variable to the nearest integer, which we store in the “Cells_called_in_delay” variable, which is equal to the area of a bar 13 that may correspond to a physical (whole) number of cells called during an interval.

Furthermore, the difference 14 between the actual value of the area and this area rounded to the nearest integer is stored in memory and totaled with the other differences existing over the other intervals [tk; tk+1]. If the integer part of this difference is not equal to zero, we add this integer part (positive or negative) to the number of cells liable to switch over the following interval. We thus ensure that the total area of the bars 13 is equal to Na. In other words, we redistribute the differences that may exist between the area of the bar and this area rounded to the nearest integer over the entire graph.

Part B of the algorithm of FIG. 2 includes instructions making it possible to redistribute the differences 14 calculated. To this end, the “difference” variable corresponds to the total of the differences between the actual cell values and these values rounded to the nearest integer. The integer part (INT) of the “difference” variable is added to the number of cells liable to switch over the time interval, if this integer part is different from 0. However, in general, the differences between values rounded up to the nearest integer and values rounded down may offset one another naturally and in that case it is not necessary to perform this set-off calculation in order to use the method according to the invention.

Additionally, in the method according to the invention, we assume that over the first time interval [t0; t1], at least one cell switches over, even if the number of cells switching during this first interval rounded to the nearest integer is 0. This choice makes it possible to best approximate the behavior of the switching cells, since it is clear that at the start of the switching activity of block 3.3 at least one cell switches. However, it is not necessary to assume that at least one cell switches over the first time interval [t0; t1] to use the method according to the invention.

Part C of the algorithm of FIG. 2 thus includes instructions making it possible to ensure that at least one cell switches during the first time interval. To this end, if the first interval (k=1) is involved and the number of cells liable to switch over this interval is equal to 0 (Cells_called_in_delay=0), then we assign the value 1 to the number of cells liable to switch over during this first interval. We thus decrement the “difference” variable by 1.

We also maintain the continuity in the switching of the cells that can be observed during operation of the circuit. In reality, if there are no more cells that switch, this means that all the cells liable to switch have switched. We thus avoid assigning zero cell values to an interval [tk; tk+1] when all the cells of the circuit liable to switch over have not yet been called. In other words, we avoid leaving intervals without switching cells, and resuming switching later, for these intervals without switching would be inconsistent in the continuity of the circuit's processing of the information.

Part D of the algorithm of FIG. 2 thus makes it possible to assign a nonzero value to the “Cells_called in_delay” variable representing, as has been seen, the number of cells liable to be called during an interval when the number of cells during this interval should be equal to zero according to the algorithm, but when the area of the Poisson curve is not equal to the number of cells (Na) liable to switch in block 3.3. Here, again, the “difference” variable is decremented by 1 to offset this cell that was allocated to the interval, over the following interval.

After having obtained the bar graph 12, we allocate a random time period to each cell over each time interval [tk; tk+1]. For a time interval [tk; tk+1] and for a cell liable to switch over this time interval, this time period is equal to k.tm+rand( ).tm, rand( ) being a function giving a random value between 0 and 1. This choice makes it possible to smooth the current calls within a time interval [tk; tk+1] during which the call is made over an interval and not strictly at instants k.tm with k integer (which could also be possible).

Here, for example, we randomly select 2 cells to which we assign respectively a switching instant equal, for example, to tm+0.1tm and to tm+0.3tm compared to the start of the clock period. We then randomly select 5 other cells that are called over [t1; t2] at instant 2tm+rand( ).tm compared to the start of the clock period, etc. The cells are selected without replacement, that is, once a cell has been randomly selected, it can no longer be randomly selected.

Effectively, when modeling the switching activity according to a Poisson model, we ignore glitches, that is, consecutive calls of one cell that are not useful for the circuit's processing of the information. We then obtain a change in the number of cells called between each interval.

The distribution of the switching instants for cells 4.1-4.1 of block 3.3 occurs each time a rising edge 17 or a falling edge 18 of a clock signal CLK or reference signal is observable. A single reference signal is defined for all the digital blocks of the electronic system.

However, as shown in FIG. 3, a digital block 3.1-3.K may have several switching activity profiles 12 over a clock period Tclk, a same activity profile being repeated within the clock period. Two successive profiles 12 may be separated from one another by a nonzero time period.

This increase in switching profiles can be observed when digital block 3.1-3.K operates at multiple frequencies fmult=1/Tmul of the frequency of the clock signal CLK. In this case, the switching profile is repeated Tclock/Tmult times.

The increase in profiles can also be observed on different edges, for example on the rising clock edge and on the falling clock edge. In this case, the same Poisson model is repeated on both edges.

In the example shown, digital block 3 operates at a frequency four times greater than the frequency of the clock signal CLK.

There may be a time lag Td between the start of the reference period of the system Tclk and the start of the switching activity of digital block 3.1-3.K. This time lag Td may, for example, be due to a response time of digital block 3.1-3.K tied to the clock signal that passes through other circuits or through a clock tree before being applied to the digital block.

Additionally, in the mixed signal system 1 comprising a number of digital circuits 3.1-3.K, we may have a distribution of switching instants per circuit and model the activities of each circuit 3.1-3.K. We then use a parameter set of the adapted Poisson distribution specific to each digital circuit 3.1-3.K.

In a particular application, to calculate the observable noise in digital block 3.3, we associate noise injection spectra with cells 4.1-4.1 as well as a time period compared to the clock edge for the effective call time of the injected noise waveform, this time period being calculated using Poisson modeling 12. We thus obtain for each cell a resulting spectrum that is the spectrum multiplied by a frequency delay operator. It is then possible to combine these resulting spectra to calculate the total noise of a block. And it is then possible to combine these block noises to calculate the total noise injected in the system 1 for a given switching activity model.

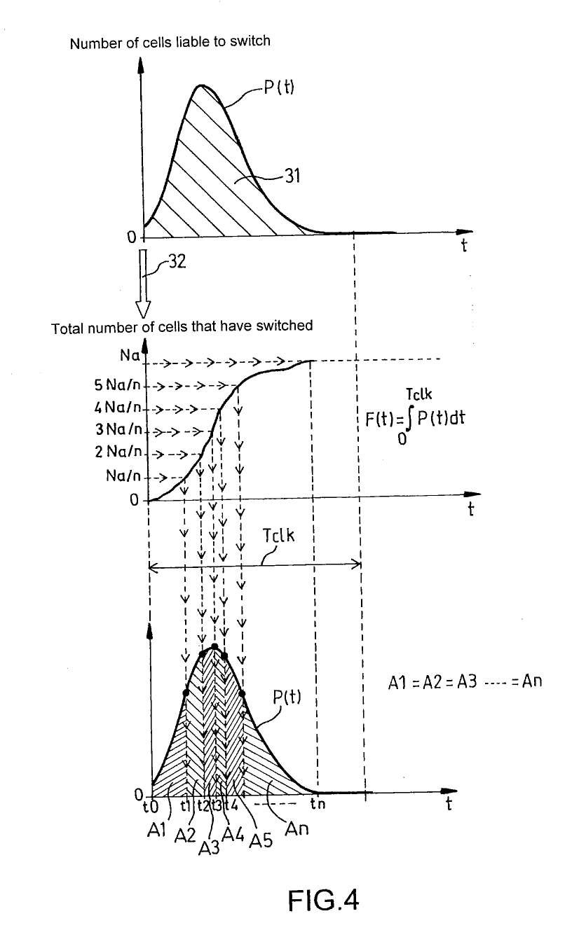

As a variant, as shown in FIG. 4, we search for different time intervals [tq; tq+1] for which a same number of cells have switched.

To this end, we approximate the discrete Poisson distribution D[k] associated with the instants tk via a continuous function P(t), for example a polynomial function with the equation P(t)=a0+a1.t+a2.t̂2+ . . . +ar.t̂r that was obtained using the least squares approximation method. We then obtain a continuous expression of the Poisson distribution, with a very slight error compared to the discrete values D[k].

The area under the curve P(t) indicates the number of cells liable to switch for a time interval associated with this area. The total area 31 under the curve P(t) is thus equal to the total number Na of cells of the digital circuit liable to switch. The Na cells considered as liable to switch are selected at random in the manner indicated previously.

To obtain the change in the total cells that switched as a function of time, we integrate 32 the function P(t) into [0, Tclk] and we get a function F(t) whose graphic representation is given. This integration is easy to calculate since the function P(t) is a polynomial. The curve F(t) is increasing so that at the start of the clock period Tclk, no cell of the circuit has switched yet and at the end of the clock period Tclk, all the cells Na liable to switch have switched.

Then, we look for the n time intervals [tq; tq+1] for each of which a same number Na/n of cells is liable to switch. n is selected so that Na/n is a whole number of cells. In the example shown in FIG. 4, n=6, Na being a multiple of 6.

To this end, we solve the function F(t) for different values of the number of cells called, these values being multiples of the number of calls Na/n. Thus, we look for tq for F(tq)=q*Na/n and q integer ranging from 1 to n, or for F(t1)=Na/n, F(t2)=2Na/n, F(t3)=Na/n, . . . up to F(tn)=Na.

We deduce from this a series of intervals [tq; tq+1] delimiting the areas A1-An that are stored in a table. We then divide up the function times axis P(t). We then obtain different call intervals [tq; tq+1] with the same number of called cells for each subdivision of area A1-An of curve P(t). We thus have:

(tq+2−tq+1)≠(tq+1−tq)

And

$$Et$$

$${\int }_{li + 1}^{li + 2} P ( t ) d t = {\int }_{ti}^{ti + 1} P ( t ) d t$$

$$ou A 1 = A 2 = A 3 … = An$$

where A1=A2=A3 . . . =An

We note that the time intervals [tq; tq+1] have a duration that decreases over time to then increase once again. For during a clock period Tclk, the switching activity tends to increase up to a maximum of activity and then decreases.

Then, we allocate switching times to the Na cells liable to switch. To this end, we first randomly select a switching interval [tq; tq+1].

We then determine a call time in the interval selected, this call time being equal to tq+rand( )*(tq+1−tq). We have seen that rand( ) is a random function giving a value between 0 and 1.

And we allocate the call time to a cell. For a given interval [tq; tq+1], the assignment of a random call time to a cell is repeated Na/n times.

We assume that it is not possible to assign a call time to a cell to which a call time has already been assigned. From a statistical standpoint, the cells are thus selected without replacement.

Just as previously, the switching profile may be repeated several times within a clock period Tclk.

Of course, the different steps of the method according to the invention may be implemented by a electronic circuit or using a software executed by a computer, the software being saved on a diskette, a CD, DVD, USB memory or any other equivalent medium. The invention extends to the circuit manufacturing method including a preliminary switching activity modeling step according to the invention, as well as to the software making it possible to implement the invention.

1-17. (canceled)

18. A method for modeling the switching activity of a digital circuit (3.3), this digital circuit (3.3) comprising cells (4.1-4.L) linked together by interconnections (6), these cells (4.1-4.L) switching at an instant at which at least one of their inputs changes state, successive switchings of the cells of the circuits (3.3) occurring during a clock period Tclk of this circuit, this clock period Tclk being the time period over which a signal applied to the circuit input is processed by the cells of this digital circuit (3.3),
wherein, as the clock period is divided into time intervals [tk, tk+1], the clock period includes the following steps:
calculating, based on an adapted statistical model, the number of cells liable to switch over each time interval [tk, tk+1] of the clock period, and
allocating switching instants to the different cells (4.1-4.L) of the digital circuit (3.3) based on the knowledge of the number of cells liable to switch over the time intervals [tk; tk+1].

19. The method of claim 18 including embedding the method in software, a computer or an electronic circuit.

20. The method of claim 18, including:
forming the statistical model as a Poisson statistical distribution model.

21. The method of claim 20, including adapting the Poisson model is an adapted model with the equation:
$$D [ k ] = e \hat{} λ \cdot \frac{λ \hat{} k}{k !} \cdot Na$$
$$Avec λ = \frac{log ( ( \overline{fa} - 1 ) \cdot Na + 1 )}{log ( \overline{fa} )}$$
where
tk is equal to tk=k.tm, k is an integer belonging to [0; int (Tclk/tm)] and tem is a constant duration shorter than the clock period Tclk,
Na is the number of cells of the circuit liable to be called over a clock period Tclk,
f̅a̅ is the average number of cells connected to the output of each cell.

22. The method of claim 21, including:
defining the number of cells (Na) of the circuit liable to switch as being equal to the number of cells of the circuit (L), or to half of this number of cells of the circuit for an average switching activity of this circuit.

23. The method of claim 21, including:
determining the number of cells (Na) by resolution of a graph with the call probabilities for the cells and the probabilities of a change of state of the different nodes between cells, a node corresponding to an interconnection between several cells.

24. The method of claim 21, including:
defining tm as the minimum duration for the transmission of information from one cell to another inside the digital circuit, this transmission duration including the minimum switching time of a cell and the minimum transmission time of a signal over an interconnection.

25. The method of claim 21, including:
to calculate the number of cells liable to switch over a time interval, the following steps are taken:
calculating a linear interpolation between D[k] and D[k+1] for the time intervals where
S[i]=D[k+1]+D[k]])/2 with i belonging to [0; int(Tclk/tm)−1], int(Tclk/tm) representing the integer part of Tclk/tm,
multiplying S[i] by the time interval tm, in order to get an approximate value of the area of the adapted Poisson distribution over each time interval [tk; tk+1], and
rounding the values of S[i].tm to the nearest integer in order to get the whole number of cells liable to switch for each time interval [tk; tk+1].

26. The method of claim 25, including:
offsetting the difference between the actual value of S[i].tm and the integer value of S[i].tm over all the time intervals.

27. The method of claim 25, including:
adapting the number of cells switching at the start of the switching activity, that is, over the first time interval [t0; t1] so that it is at least equal to one.

28. The method of claim 25, including:
maintaining a continuous chain in the switching activity of the cells (4.1-4.L), all the cells of the circuit liable to switch must have switched if the number of cells liable to switch over an interval [tk; tk+1] becomes zero.

29. The method of claim 25, including:
for allocating switching instants to the different cells, the following steps for each time interval [tk; tk+] are included:
randomly selecting in the circuit a number of cells equal to the number of cells liable to switch over this time interval, and
allocating to these randomly selected cells a switching instant that is itself selected randomly over the time interval [tk; tk+1],
this switching instant is equal to k.tm+rand( ).tm, tm is equal to the duration of a time interval [tk; tk+1] and rand( ) is a random value between 0 and 1.

30. The method of claim 25, including:
selectively no longer randomly selecting the cells to which a switching instant has been allocated.

31. The method of claim 25, including:
calculating a continuous polynomial function P(t) approximating according to the least squares method the discrete distribution D[k] associated with instants tk,
integrating the continuous function P(t) in the duration [0; Tclk] and obtain a function F(t),
finding tq by solving F(tq)=q*Na/n, for q integer from [0 to n], n being selected so that Na/n is a whole number,
deducing the successive n time intervals [tq; tq+1] for each of which a same number Na/n of cells is liable to switch, and
allocating a switching time period based on these intervals to Na cells selected randomly as liable to switch.

32. The method of claim 20, including allocating a switching time period to each of the cells by means of the following steps:
randomly select a time interval [tq; tq+1],
calculating a call time in the selected interval, this call time being equal to tq+rand( )*(tq+1−tq), rand( ) being a random function giving a value between 0 and 1, and
allocating the call time to a cell, the allocation of a call time to a cell being repeated Na/n times for each given interval [tq; tq+1].

33. The method of claim 18, including:
using several Poisson models are used within the clock period Tclk to determine the circuit's switching activity when the digital circuit (3.3) operates at a multiple frequency (fmult) of the clock signal (CLK) or on a rising edge or on a falling edge of the clock signal.

34. A production method including a determined preliminary switching activity modeling step, the modeling step including modeling the switching activity of a digital circuit (3.3), this digital circuit (3.3) comprising cells (4.1-4.L) linked together by interconnections (6), these cells (4.1-4.L) switching at an instant at which at least one of their inputs changes state, successive switchings of the cells of the circuits (3.3) occurring during a clock period Tclk of this circuit, this clock period Tclk being the time period over which a signal applied to the circuit input is processed by the cells of this digital circuit (3.3),
wherein, as the clock period is divided into time intervals [tk, tk+1], the clock period includes the following steps:
calculating, based on an adapted statistical model, the number of cells liable to switch over each time interval [tk, tk+1] of the clock period, and
allocating switching instants to the different cells (4.1-4.L) of the digital circuit (3.3) based on the knowledge of the number of cells liable to switch over the time intervals [tk; tk+1].
